(19) United States
(12) Patent Application Publication
(10) Pub. No.: US 2008/0232024 A1
(43) Pub. Date: Sep. 25, 2008

(54) METALIZED PLASTIC FILM FOR FILM CAPACITOR AND FILM CAPACITOR

(75) Inventors: Chang Hoon Yang, Cheonan-City (KR); Dae Jin Park, Cheonan-City (KR); Young Won Jun, Yesan-Gun (KR)

Correspondence Address: SCHMEISER OLSEN & WATTS, 18 E UNIVERSITY DRIVE, SUITE # 101, MESA, AZ, 85201, US

(73) Assignee: NUINTEK CO., LTD., Chungcheongnam-Do (KR)

(21) Appl. No.: 11/855,045

(22) Filed: Sep. 13, 2007

(30) Foreign Application Priority Data
Mar. 22, 2007 (KR) 10-2007-27943

(51) Int. Cl. H01G 4/005

(52) U.S. Cl. 361/303

(57) ABSTRACT

A metalized plastic film for a rolled film capacitor or a laminated film capacitor and a film capacitor are disclosed. The metalized plastic film having a plastic film and an electrode metal deposited on the plastic film and patterned for a film capacitor includes rectangular split electrodes extending from a margin region defined at one side of the plastic film as a region free of the deposited electrode metal toward an opposite side of the plastic film, to have a length corresponding to about one fourth to four fifth of a width of the plastic film, the split electrodes being continuously arranged at specified intervals in a longitudinal direction of the plastic film, fuse portions each formed in an associated one of the split electrodes between the margin region and an electrode metal contacting region of the associated split electrode. Therefore, it is possible to reduce self-heating of the film capacitor and prevent capacitance of the film capacitor from decreasing due to an operation of the fuse portions, thereby ensuring safety of the capacitor, scaling down the capacitor and using the capacitor at a high temperature.

### BACKGROUND OF THE INVENTION

1. Field of the Invention

The present invention relates to a metalized plastic film for a rolled film capacitor or a laminated film capacitor and a film capacitor, and more particularly to a metalized plastic film for a film capacitor and a film capacitor capable of reducing self-heating of the film capacitor and preventing capacitance of the film capacitor from decreasing due to an operation of a fuse portion, thereby improving electric characteristics, safety and heat resistance of the capacitor to scale down the capacitor and use the capacitor at a high temperature.

2. Description of the Related Art

In general, low voltage power capacitors, capacitors for use in electric and electronic equipment and the like are widely used in various industries. The capacitor is generally formed by rolling a metalized plastic film that includes a plastic film serving as a dielectric and metal serving as an electrode, wherein the metal is deposited on one or both surfaces of the plastic film at a high vacuum level. The plastic film serving as a dielectric is selected from the group consisting of polyethylene terephthalate resin, polypropylene resin, polyethylene naphthalate resin, polycarbonate resin and the like. The metal serving as an electrode is selected from the group consisting of zinc (Zn), aluminum (Al), aluminum alloy and the like.

Zinc or zinc alloy for electrode extraction is sprayed on both surfaces of the rolled metalized plastic film and electrode extraction lines are connected thereto by spotting, soldering or the like. Then, the rolled metalized plastic film is enclosed in an external case and insulated using an insulating material.

The above-mentioned capacitor has the following problems. An additional safety device is enclosed in the external case to ensure safety and use the capacitor at a high voltage, thereby increasing the size and price of the capacitor. Further, when the safety device is operated due to generation of a voltage higher than a withstand voltage, the capacitor loses its function.

In order to overcome the above problems and ensure safety, a capacitor using a metalized plastic film including fuse portions or a patterned metalized plastic film has been proposed. That is, before the metal is deposited on the surface of the plastic film, a release agent such as oil is coated on certain portions of the plastic film into a specified shape. Accordingly, the metal is not deposited on the release agent-coated portions and the deposited metal is divided into split electrodes. The split electrodes include respectively the fuse portions having a width smaller than that of the split electrodes.

FIG. 1 shows a general type metalized plastic film for use in a conventional film capacitor. A metalized plastic film 8 shown in FIG. 1 includes a plastic film 1 and an electrode metal 2 deposited on the plastic film 1. In this case, the electrode metal 2 is not divided into the split electrodes. Instead, an additional safety device such as a temperature fuse, a current fuse or a device for isolating the capacitor from a power supply by gas generated upon damage of the capacitor may be built in the external case to ensure safety of the capacitor. Further, the metalized plastic film with a 3 μm˜5 μm greater thickness may be used to ensure safety of the capacitor. Thus, it causes problems such as an increase in the size and price of the capacitor.

As shown in FIG. 2A, the metalized plastic film 8 for use in a conventional film capacitor may include the deposited electrode metal 2 divided by T-shaped separation portions 3. That is, when the electrode metal 2 is deposited on the plastic film 1, the deposited metal 2 is divided into split electrodes 5 by the T-shaped separation portions 3 and each split electrode 5 includes one of fuse portions 4.

When an insulation breakdown occurs in a certain split electrode 5, deposited metal of the fuse portion 4 of the split electrode 5 is removed by current causing the insulation breakdown. Accordingly, the fuse portion 4 isolates the failed split electrode 5 from the power supply. Thus, although a reduction in the capacitance of the capacitor corresponding to the area of the split electrode 5 occurs, the fuse portion 4 prevents the capacitor from blowing up, whereby the capacitor can continuously perform its function.

Further, the capacitor includes a margin region 6 defined at one end of the plastic film 1 as a region free of the deposited metal 2 and a sprayed metal contact region 7 formed at an opposite end of the metalized plastic film 8. The margin region 6 and the sprayed metal contact region 7 extend in the longitudinal direction of the plastic film 1.

In the capacitor including the metalized plastic film 8 shown in FIG. 2A, the fuse portions 4 are close to the sprayed metal contact region 7. Accordingly, heat generated in the fuse portions 4 is added to the heat generated in the sprayed metal contact region 7, thereby increasing the temperature of the capacitor and decreasing the insulation property in those portions. Thus, the fuse portions 4 cannot safely perform their functions.

Further, when the metalized plastic film 8 has a width of 40 mm or more, the area of the split electrode 5 becomes large and the width of the fuse portion 4 becomes large. Accordingly, the fuse portion 4 may not operate properly.

On the other hand, when the fuse portion 4 operates properly, there is a problem such as a significant reduction of the capacitance. Accordingly, as shown in FIG. 2B, the metalized plastic film 8 including three or two fuse portions 4 has been proposed. However, the metalized plastic film 8 shown in FIG. 2B also causes the above-mentioned problems. Namely, it is difficult to ensure safety of the fuse portions 4. Further, when the fuse portion 4 operates properly, a capacitance reduction ratio of the capacitor is high due to a large area of the split electrode 5.

As shown in FIG. 3, the metalized plastic film 8 for use in a conventional film capacitor may include the deposited metal 2 that is divided into the diamond-shaped split electrodes 5 by the separation portions 3. The respective sides of the split electrodes 5 are connected to the fuse portions 4.

The current applied to the electrode extraction line flows from the sprayed metal contact region 7 of the metalized plastic film 8 toward the margin region 6. In the metalized plastic film 8 shown in FIG. 3, a plurality of the split electrodes 5 is disposed in the width direction of the metalized plastic film 8. Accordingly, the number of the fuse portions 4 increases and a large amount of heat is generated due to a bottleneck phenomenon of current in the fuse portions 4. Thus, it is difficult to use the metalized plastic film 8 shown in FIG. 3 at a high current level.

In the metalized plastic film 8 shown in FIG. 4 for use in a conventional film capacitor, about a half of the deposited metal 2 is divided into the split electrodes 5 by the T-shaped separation portions 3. Each split electrode 5 includes four fuse portions 4. In this case, the capacitance reduction ratio of the capacitor due to the operation of the fuse portion 4 is lower than that of the capacitor using the metalized plastic film 8 shown in FIGS. 2A and 2B. However, since a pitch between the split electrodes 5 is large and the area of the split electrodes 5 is still large, the capacitance reduction ratio of the capacitor is high when the fuse portion 4 operates properly.

Further, when the capacitor is formed by rolling a pair of the metalized plastic films 8 respectively including the fuse portions 4 positioned at the central portion thereof, the fuse portions 4 converge in a central portion of the capacitor. Accordingly, a large amount of heat is generated due to a bottleneck phenomenon of current in the fuse portions 4. Thus, a withstand voltage of the capacitor is reduced, and the capacitor needs to be used under limited conditions.

In the metalized plastic film 8 shown in FIG. 5 for use in a conventional film capacitor, about a half of the deposited metal 2 is divided into the diamond-shaped split electrodes 5. Compared to the metalized plastic film 8 shown in FIG. 3, the number of the fuse portions 4 in the width direction of the metalized plastic film 8 is reduced to prevent a temperature increase generated by self-heating of the capacitor. However, since fuse portions 4a in contact with the deposited metal 2 without the split electrodes 5 have a large width, the fuse portions 4a may not operate properly. Thus, it is difficult to ensure safety of the capacitor.

### SUMMARY OF THE INVENTION

Therefore, the present invention has been made in view of the above problems, and it is an object of the present invention to provide a metalized plastic film for a film capacitor capable of dispersing heat generated due to a bottleneck phenomenon of current in fuse portions and preventing a temperature increase due to overlapping of the fuse portions by reducing the number of split electrodes and the fuse portions in the film width and spacing the fuse portions of the neighboring split electrodes from each other, and capable of reducing self-heating of the film capacitor and preventing capacitance of the film capacitor from decreasing due to an operation of a fuse portion by reducing the area of the split electrodes and the width of the fuse portions to facilitate the operation of the fuse portions, thereby improving electric characteristics, safety and heat resistance of the capacitor to scale down the capacitor and use the capacitor at a high temperature.

In accordance with an aspect of the present invention, there is provided a metalized plastic film including a plastic film and an electrode metal deposited on the plastic film and patterned for a film capacitor, comprising rectangular split electrodes extending from a margin region defined at one side of the plastic film as a region free of the deposited electrode metal toward an opposite side of the plastic film, to have a length corresponding to about one fourth to four fifth of a width of the plastic film, the split electrodes being continuously arranged at specified intervals in a longitudinal direction of the plastic film; fuse portions each formed in an associated one of the split electrodes between the margin region and an electrode metal contacting region of the associated split electrode.

In the metalized plastic film, preferably, the fuse portions have a width of 0.15 mm ˜1.0 mm. Further, preferably, the fuse portions of neighboring ones of the split electrodes are spaced 3 mm ˜40 mm apart in a width direction of the plastic film.

Further, preferably, the metalized plastic film further comprises a sprayed metal contact region formed opposite to the margin region, wherein the deposited electrode metal has a resistance of 0.5 Ω/cm²˜10 Ω/cm² in the sprayed metal contact region and the deposited electrode metal has a resistance of 2 Ω/cm²˜20 Ω/cm² in a remaining portion.

Further, preferably, the deposited electrode metal has a uniform resistance of 0.5 Ω/cm²˜20 Ω/cm².

In accordance with another aspect of the present invention, there is provided a film capacitor using the metalized plastic film.

### BRIEF DESCRIPTION OF THE DRAWINGS

The above and other objects, features and other advantages of the present invention will be more clearly understood from the following detailed description taken in conjunction with the accompanying drawings, in which:

FIG. 1 shows a perspective view of a general type metalized plastic film for use in a conventional film capacitor;

FIG. 2A shows a perspective view of a metalized plastic film for use in a conventional film capacitor, wherein a deposited metal is divided into split electrodes by T-shaped separation portions and each split electrode has one fuse portion;

FIG. 2B shows a perspective view of a metalized plastic film for use in a conventional film capacitor, wherein a deposited metal is divided into split electrodes by T-shaped separation portions and each split electrode has three fuse portions;

FIG. 3 shows a perspective view of a metalized plastic film for use in a conventional film capacitor, wherein a deposited metal is divided into diamond-shaped split electrodes;

FIG. 4 shows a perspective view of a metalized plastic film for use in a conventional film capacitor, wherein about a half of a deposited metal is divided into split electrodes by T-shaped separation portions and each split electrode has four fuse portions;

FIG. 5 shows a perspective view of a metalized plastic film for use in a conventional film capacitor, wherein about a half of a deposited metal is divided into diamond-shaped split electrodes;

FIG. 6A illustrates a perspective view showing a deposited pattern of a metalized plastic film for use in a film capacitor according to a first embodiment of the present invention;

FIG. 6B shows a development view of a film capacitor using the metalized plastic film according to the first embodiment of the present invention;

FIG. 6C is a perspective view illustrating an assembled state of the film capacitor using the metalized plastic film according to the first embodiment of the present invention;

FIG. 7A illustrates a perspective view showing a deposited pattern of a metalized plastic film for use in a film capacitor according to a second embodiment of the present invention;

FIG. 7B shows a development view of a film capacitor using the metalized plastic film according to the second embodiment of the present invention; and

FIG. 7C is a perspective view illustrating an assembled state of the film capacitor using the metalized plastic film according to the second embodiment of the present invention.

### DETAILED DESCRIPTION OF THE PREFERRED EMBODIMENTS

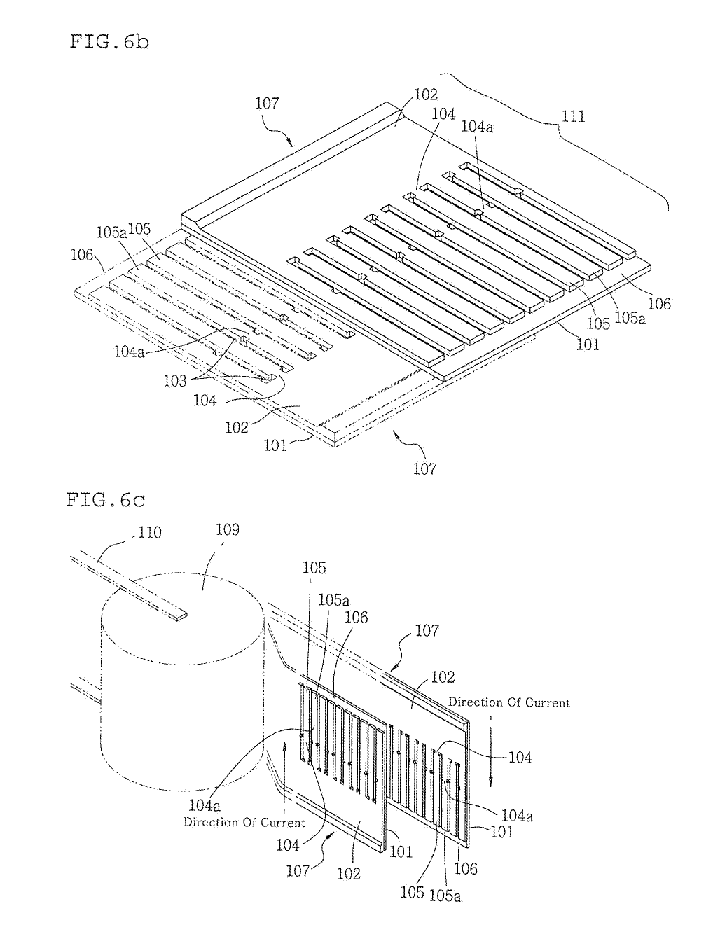

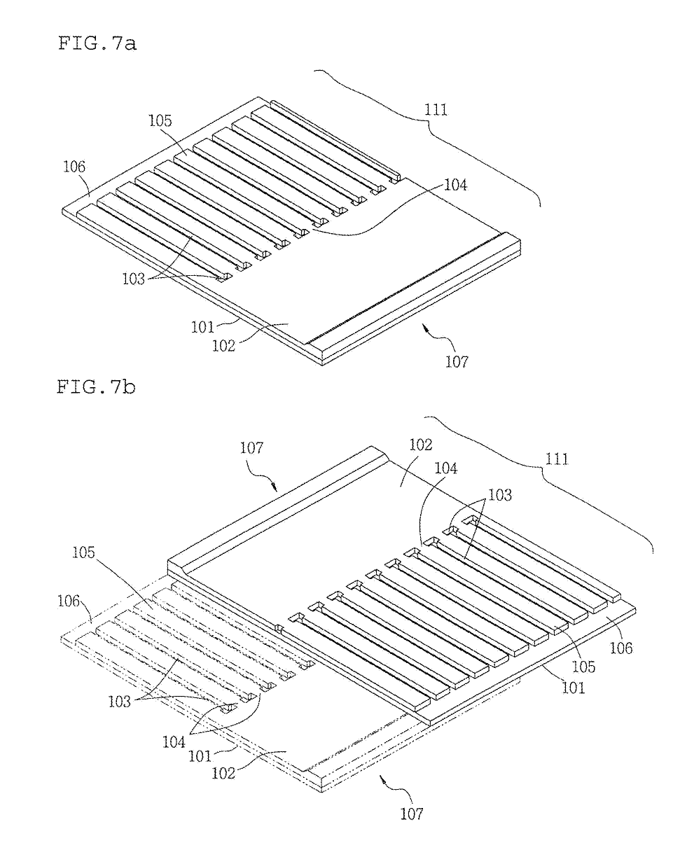

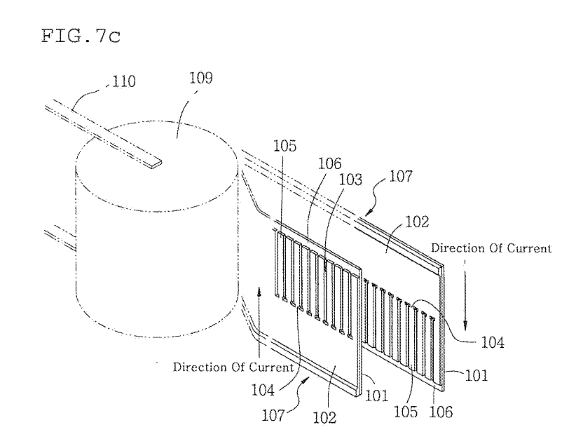

Hereinafter, first and second embodiments of the present invention will be described with reference to FIGS. 6A to 7C.

First, FIG. 6A shows a metalized plastic film 111 for use in a film capacitor in accordance with a first embodiment of the present invention. As shown in FIG. 6A, an electrode metal 102 for forming an electrode is deposited on one or both surfaces of a dielectric plastic film 101. Rectangular split electrodes 105 and 105a are arranged continuously in the longitudinal direction of the plastic film 101. Each split electrode 105 or 105a extends from a margin region 106 to have a length corresponding to about one fourth to four fifth of the width of the plastic film 101.

Further, fuse portions 104 having a width smaller than that of the split electrodes 105 are formed between the split electrodes 105 and the deposited electrode metal 102. In this case, each split electrode 105 has one of the fuse portions 104. Thus, only one fuse portion 104 is disposed in the width direction of the metalized plastic film 111.

Similarly, fuse portions 104a having a width smaller than that of the split electrodes 105a are respectively formed in the split electrodes 105a. However, the fuse portions 104a are spaced from the fuse portions 104 toward the margin region 106.

Thus, the fuse portions 104 and 104a are arranged into two lines in the longitudinal direction of the metalized plastic film 111 such that heat generated at the fuse portions 104 and 104a can be dispersed in two directions.

Further, in a capacitor including a pair of rolled metalized plastic films shown in FIG. 6B, the fuse portions 104 and 104a are arranged into three lines such that heat generated at the fuse portions 104 and 104a can be dispersed in three directions. Accordingly, high-temperature heat generation can be reduced in a central portion of the capacitor, thereby uniformly generating low-temperature heat.

Thus, it is possible to provide a capacitor having a long life span and capable of being used at the high temperature.

In comparison, referring to FIG. 4 showing a conventional capacitor having a shape similar to that of the capacitor according to the first embodiment of the present invention, since split electrodes 5 have a large area, a large amount of current flows through fuse portions 4. Since the fuse portions 4 converge in the central portion of the capacitor, high-temperature heat is generated in the center of the capacitor, thereby decreasing the insulation property of the capacitor. The life span of the capacitor is reduced and the using temperature of the capacitor is lowered. Thus, there are apparent differences between the conventional capacitor and the capacitor of the present invention.

Referring to FIG. 6A, in the first embodiment of the present invention, a sprayed metal contact region 107 is formed opposite to the margin region 106. The deposited electrode metal 102 has a resistance of 0.5 Ω/cm²˜10 Ω/cm² in the sprayed metal contact region 107 and the deposited electrode metal 102 has a resistance of 2 Ω/cm²˜20 Ω/cm² in the remaining portion. The dielectric plastic film 101 is selected from the group consisting of polyethylene terephthalate resin, polypropylene resin, polyethylene naphthalate resin, polycarbonate resin and the like. Aluminum (Al) zinc (Zn) or aluminum alloy is mainly used as the electrode metal 102 deposited on one or both surfaces of the plastic film 101. Silver (Ag), copper (Cu), nickel (Ni), chromium (Cr) or the like serves as a seed of the deposited electrode metal 102.

On the other hand, FIG. 7A shows a metalized plastic film 111 for use in a film capacitor in accordance with a second embodiment of the present invention. As shown in FIG. 7A, an elect-rode metal 102 is deposited on one or both surfaces of a dielectric plastic film 101. Rectangular split electrodes 105 are arranged continuously in the longitudinal direction of the metalized plastic film 111. Each split electrode 105 extends from a margin region 106 to have a length corresponding to about one fourth to four fifth of the width of the metalized plastic film 111. Fuse portions 104 having a width smaller than that of the split electrodes 105 are formed between the split electrodes 105 and the deposited electrode metal 102. In this case, each fuse portion 104 is formed in each split electrode 105.

A sprayed metal contact region 107 is formed in an opposite portion of the margin region 106. The deposited electrode metal 102 has a resistance of 0.5 Ω/cm²˜10 Ω/cm² in the sprayed metal contact region 107 and the deposited electrode metal 102 has a resistance of 2 Ω/cm²˜20 Ω/cm² in the remaining portion.

Also in the second embodiment of the present invention, a dielectric plastic film 101 is selected from the group consisting of polyethylene terephthalate resin, polypropylene resin, polyethylene naphthalate resin, polycarbonate resin and the like. Aluminum (Al) zinc (Zn) or aluminum alloy is mainly used as the electrode metal 102 deposited on one or both surfaces of the dielectric plastic film 101. Silver (Ag), copper (Cu), nickel (Ni), chromium (Cr) or the like serves as a seed of the deposited electrode metal 102.

Comparing the conventional metalized plastic film 8 with the metalized plastic film 111 of the first and second embodiments of the present invention, the number of fuse portions in the film width direction and the area of split electrodes in the metalized plastic film 8 or 111 having a width of 40 mm and a length of 150 mm are obtained and represented as in Table 1.

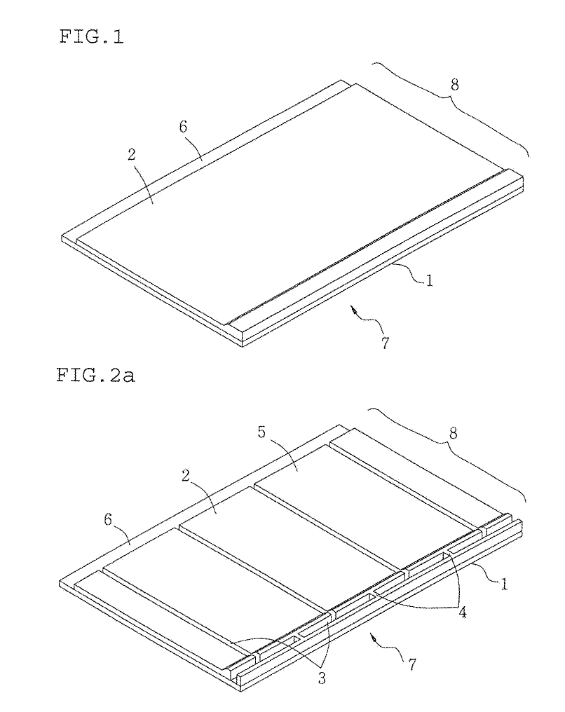

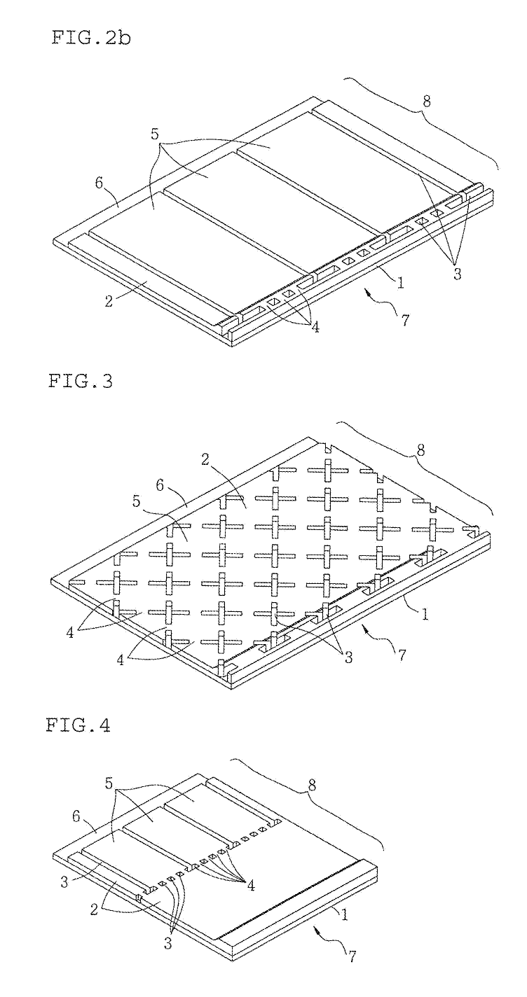

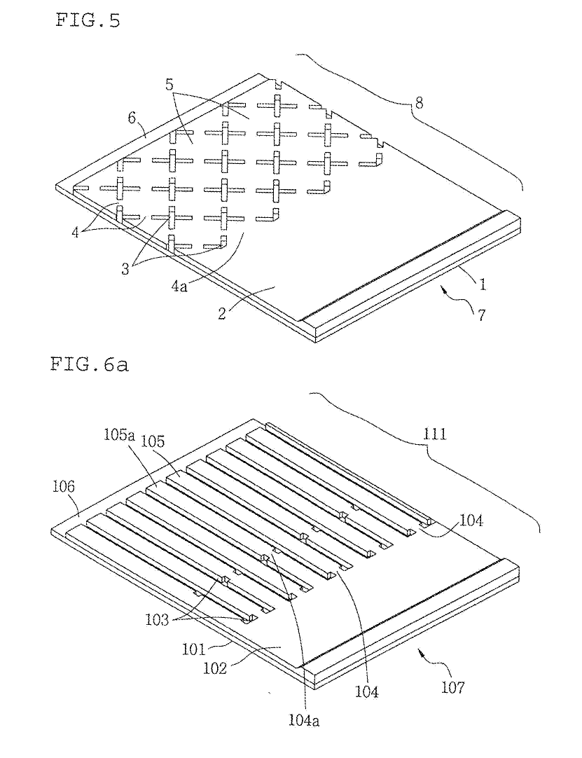

TABLE 1

| | | Number of fuse portions in | | | |
|---|---|---|---|---|---|
| | | film width direction | | | Area (mm²) of |
| Items | | A | B | Total | split electrodes |
| Conventional | FIG. 1 | 0 | 0 | 0 | 525 |
| examples | FIG. 2A | 1 | 0 | 1 | 595 |
| | FIG. 2B | 1 | 0 | 1 | 700 |
| | FIG. 3 | 1 | 9 | 10 | 32 |
| | FIG. 4 | 0 | 1 | 1 | 350 |
| | FIG. 5 | 0 | 5 | 5 | 32 |
| First | FIG. 6A | 0 | 1 | 1 | 65 |
| embodiment | | | | | |
| Second | FIG. 6B | 0 | 1 | 1 | 65 |
| embodiment | | | | | |

A: Number of fuse portions in sprayed metal contact region

B: Number of fuse portions in metal-deposited surface

As represented in Table 1, in the conventional metalized plastic film 8 for use in a film capacitor, the number of the fuse portions 4 in the film width direction is 1˜10 and the area of split electrodes 5 is 32 mm²˜700 mm². When the number of the fuse portions 4 in the film width direction is one as in the metalized plastic film 8 shown FIGS. 2A and 2B, a small amount of heat is generated in the capacitor, whereas the area of split electrodes 5 is large (i.e., 595 mm²˜700 mm²) and a capacitance reduction ratio is high. When the area of split electrodes 5 is small (i.e., 32 mm²) as in the metalized plastic film 8 shown FIGS. 3 and 5, the number of the fuse portions 4 in the film width direction is 5˜10, so that a large amount of heat is generated in the capacitor.

After manufacturing capacitors with a capacitance of 100 μF using the conventional metalized plastic film 8 and the metalized plastic film 111 of the first and second embodiments of the present invention, each film having a width of 50 mm, when a voltage of 600 V and current of 20 A are applied to the capacitors, the increasing temperature of the capacitors is measured and represented as in Table 2.

TABLE 2

| | | Increasing temperature (° C.) | |
|---|---|---|---|
| | | | Central portion of |
| | | Sprayed metal contact | capacitor in width |
| Items | | region of capacitor | direction |
| Conventional | FIG. 1 | 6 | 4 |
| examples | FIG. 2A | 14 | 4 |
| | FIG. 3 | 14 | 7 |
| | FIG. 4 | 6 | 8 |
| First | FIG. 6A | 6 | 5 |
| embodiment | | | |
| Second embodiment | FIG. 7A | 6 | 6 |

As represented in Table 2, in the conventional capacitor, there is heat generation in the sprayed metal contact region 7 due to contact resistance between the sprayed metal of the capacitor and the metalized plastic film 8. There is heat generation in the fuse portions 4 due to a bottleneck phenomenon of current in the fuse portions 4. Also, since the fuse portions 4 are close to each other, the temperature of the fuse portions 4 becomes higher than the other portion. The temperature of the central portion of capacitor in the width direction increases according to the number of the fuse portions 4 in the width direction.

In the metalized plastic film 8 for use in the conventional film capacitor shown in FIGS. 2A and 3, the sprayed metal contact region 7 of the capacitor has the temperature increase of 14° C. although the sprayed metal contact region 7 shown in FIG. 4 has the temperature increase of 6° C. However, in the metalized plastic film 111 shown in FIGS. 6A and 7A in accordance with the first and second embodiment of the present invention, the sprayed metal contact region 107 of the capacitor has a small temperature increase of 6° C. The central portion of capacitor has a smaller temperature increase of 5° C. ˜6° C. than that of the conventional similar capacitor shown in FIG. 4.

Compared to the conventional metalized plastic film 8, the metalized plastic film 111 shown in FIG. 6A in accordance with the first embodiment of the present invention has the following advantages. Since the area of the split electrodes 105 is small (i.e., 65 mm²), the capacitance reduction ratio of the capacitor is low. Further, only one of the fuse portions 104 and 104a is disposed in the film width direction, thereby decreasing heat generation of the capacitor due to a bottleneck phenomenon of current in the fuse portions 104 and 104a. Furthermore, in order to prevent a temperature increase of the capacitor due to the fuse portions 104 disposed at the central portion of capacitor when the capacitor is formed by rolling a pair of the metalized plastic films, the fuse portions 104a of the split electrodes 105a adjacent to the fuse portions 104 are spaced from the fuse portions 104 toward the margin region 106. Accordingly, the fuse portions 104 and 104a are arranged into two lines in the longitudinal direction of the metalized plastic film 111 such that heat generated at the fuse portions 104 and 104a can be dispersed in two directions.

In the capacitor including a pair of rolled metalized plastic films shown in FIGS. 6B and 6C, the fuse portions 104 and 104a are arranged into three lines such that heat generated at the fuse portions 104 and 104a can be dispersed in three directions. Accordingly, high-temperature heat generation can be reduced in the central portion of the capacitor, thereby uniformly generating low-temperature heat to ensure safety.

In the metalized plastic film 111 shown in FIG. 7A in accordance with the second embodiment of the present invention, the area of the split electrodes 105 is small (i.e., 65 mm²), resulting in a low capacitance reduction ratio of the capacitor. Further, only one of the fuse portions 104 is disposed in the film width direction, thereby decreasing heat generation of the capacitor due to a bottleneck phenomenon of current in the fuse portions 104. The rectangular split electrodes 105 extend from a margin region 106 to have a length corresponding to about one fourth to four fifth of the width of the metalized plastic film 111. Accordingly, in the capacitor including a pair of rolled metalized plastic films shown in FIGS. 7B and 7C, the fuse portions 104 are arranged into two lines such that heat generated at the fuse portions 104 can be dispersed in two directions. Thus, high-temperature heat generation can be reduced in the central portion of the capacitor, thereby uniformly generating low-temperature heat to ensure safety.

Although one fuse portion 104 or 104a is formed in each split electrode 105 or 105a in the embodiments of the present invention, the number of the fuse portions 104 or 104a formed in each split electrode 105 or 105a can vary according to the purpose of the manufacturer. The positions of the fuse portions 104 and 104a spaced from each other can vary in the split electrodes 105 and 105a extending to have a length corresponding to about one fourth to four fifth of the film width without being limited to the above embodiments described with reference to the accompanying drawings.

Therefore, it is possible to lengthen the life span of the capacitor and improve the characteristics of the capacitor such that the capacitor can be used at a high temperature.

After manufacturing capacitors with a capacitance of 100 μF using the conventional metalized plastic film 8 and the metalized plastic film 111 of the first and second embodiments of the present invention, each film having a width of 50 mm, when a voltage of 600 V and current of 20 A are continuously applied to the capacitors for 1500 hours, the capacitance reduction ratio of the capacitor is obtained. When the voltage is increased until the capacitance of the capacitors is reduced by 95% or more and the number of withstand voltage-detected samples versus the number of the samples is obtained. The results are represented as in Table 3.

TABLE 3

| | | | Number of withstand |
|---|---|---|---|
| | | | voltage-detected |
| | | Capacitance reduction | samples/ |
| Items | | ratio (%) | number of samples |
| Conventional | FIG. 2A | 5.0 | 6/10 |
| examples | FIG. 3 | 3.5 | 1/10 |
| | FIG. 4 | 4.5 | 0/10 |
| | FIG. 5 | 2.5 | 3/10 |
| First | FIG. 6A | 1.5 | 0/10 |
| embodiment | | | |
| Second | FIG. 7A | 1.5 | 0/10 |
| embodiment | | | |

As represented in Table 3, in a test of continuously applying a voltage and current to the capacitors for 1500 hours, the capacitors according to the present invention which have a capacitance reduction ratio of 1.5% has a superior performance than the conventional capacitors having a capacitance reduction ratio of 5.0%˜2.5%. In a test of increasing the voltage step by step, the capacitors according to the present invention are very safe because there is no withstand voltage-detected sample until the capacitance of the capacitors is reduced by 95%.

Although the split electrodes 105 and 105a have the same area in the first embodiment of the present invention, the same effect can also be obtained when the split electrodes 105 have a larger area than the split electrodes 105a or the split electrodes 105a have a larger area than the split electrodes 105. Although the separation portions 103 have the same width in the longitudinal direction in the embodiments of the present invention, the width of the separation portions 103 can vary. Although only one of the fuse portions 104 and 104a is disposed in the film width direction in the embodiments of the present invention, the number of the fuse portions is not limited thereto.

Further, the fuse portions 104a of the split electrodes 105a adjacent to the fuse portions 104 are spaced at a specified distance from the fuse portions 104 in the first embodiment of the present invention, the spaced distance can vary.

As described above, in the metalized plastic film for use in the film capacitor according to the present invention, the electrode metal is deposited on one or both surfaces of the plastic film serving as a dielectric and the area of each split electrode is reduced. The electrode metal is patterned such that the split electrodes are arranged continuously in the longitudinal direction of the metalized plastic film and each split electrode extends from a non-deposited margin region to have a length corresponding to about one fourth to four fifth of the width of the metalized plastic film. Each split electrode includes a metal deposited portion extending toward an opposite portion of the non-deposited margin region and one fuse portion. The fuse portions of neighboring split electrodes are spaced at a specified distance from each other. Thus, the fuse portions are arranged into two lines in the longitudinal direction of the metalized plastic film such that heat generated due to a bottleneck phenomenon of current in the fuse portions can be dispersed in two directions.

Further, in a capacitor including a pair of rolled metalized plastic films, the fuse portions are arranged into two or three lines such that heat generated due to a bottleneck phenomenon of current in the fuse portions can be dispersed in two or three directions. Accordingly, high-temperature heat generation can be reduced in the central portion of the capacitor. Thus, it is possible to lengthen the life span of the capacitor and prevent capacitance of the capacitor from decreasing, thereby improving reliability of the capacitor. Also, the capacitor can be used at a high temperature.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A metalized plastic film including a plastic film and an electrode metal deposited on the plastic film and patterned for a film capacitor, comprising:
rectangular split electrodes extending from a margin region defined at one side of the plastic film as a region free of the deposited electrode metal toward an opposite side of the plastic film, to have a length corresponding to about one fourth to four fifth of a width of the plastic film, the split electrodes being continuously arranged at specified intervals in a longitudinal direction of the plastic film;
fuse portions each formed in an associated one of the split electrodes between the margin region and an electrode metal contacting region of the associated split electrode.

2. The metalized plastic film according to claim 1, wherein the fuse portions have a width of 0.15 mm˜1.0.mm.

3. The metalized plastic film according to claim 1, wherein the fuse portions of neighboring ones of the split electrodes are spaced 3 mm ˜40 mm apart in a width direction of the plastic film.

4. The metalized plastic film according to claim 2, wherein the fuse portions of neighboring ones of the split electrodes are spaced 3 mm˜40 mm apart in a width direction of the plastic film.

5. The metalized plastic film according to claim 1, further comprising:
a sprayed metal contact region formed opposite to the margin region, wherein the deposited electrode metal has a resistance of 0.5 Ω/cm²˜10 Ω/cm² in the sprayed metal contact region and the deposited electrode metal has a resistance of 2 Ω/cm²˜2 Ω/cm² in a remaining portion.

6. The metalized plastic film according to claim 1, wherein the deposited electrode metal has a uniform resistance of 0.5 Ω/cm²˜20 Ω/cm².

7. A film capacitor using the metalized plastic film manufactured according to claim 1.

8. A film capacitor using the metalized plastic film manufactured according to claim 2.

9. A film capacitor using the metalized plastic film manufactured according to claim 3.

10. A film capacitor using the metalized plastic film manufactured according to claim 4.

11. A film capacitor using the metalized plastic film manufactured according to claim 5.
